(19) United States
(12) Patent Application Publication
(10) Pub. No.: US 2006/0211843 A1
(43) Pub. Date: Sep. 21, 2006

(54) Methods of synthesis of poly(succinimide-aspartate) polysuccinimide or polyaspartate by end capping polymerization

(76) Inventors: Graham Swift, Chapel Hill, NC (US); George H. Redlich, East Norriton, PA (US)

Correspondence Address: STAMATIOS MYLONAKIS, 7009 CASHELL MANOR COURT, DERWOOD, MD, 20855-1201, US

(21) Appl. No.: 11/440,140

(22) Filed: May 25, 2006

Related U.S. Application Data
(63) Continuation-in-part of application No. 10/698,375, filed on Nov. 3, 2003, now Pat. No. 7,074,881.
Application No. 10/698,375 is a continuation-in-part of application No. 10/307,349, filed on Dec. 2, 2002, now Pat. No. 6,686,440.
Application No. 10/698,375 is a continuation-in-part of application No. 10/307,387, filed on Dec. 2, 2002, now Pat. No. 6,686,441.
Application No. 10/307,349 is a continuation of application No. 09/776,897, filed on Feb. 6, 2001, now Pat. No. 6,495,658.
Application No. 10/307,387 is a continuation-in-part of application No. 09/776,897, filed on Feb. 6, 2001, now Pat. No. 6,495,658.

(51) Int. Cl. C08G 69/10; C08G 73/00

(52) U.S. Cl. 528/328; 528/363

(57) ABSTRACT

Disclosed are methods of synthesis of homopolymers or copolymers containing succinimide or aspartate moieties formed in the presence of an end capping initiator. Also disclosed are methods of isolating, compounding, stabilizing and processing the homopolymers and copolymers.

This application is a Continuation-In-Part application Ser. No. 10/698,375, filed Nov. 03, 2003; and is a Continuation-In-Part of application Ser. Nos. 10/307,349 now U.S. Pat. Nos. 6,686,440 and 10/307,387, now U.S. Pat. No. 6,686,441 both filed Dec. 2, 2002, which are a Continuation and Continuation-In-Part, respectively, of application Ser. No. 09/776,897, filed Feb. 6, 2001, now U.S. Pat. No. 6,495,658, issued Dec. 17, 2002, all three of which are incorporated herein by reference in their entirety.

### BACKGROUND OF THE INVENTION

1. Field of the Invention

The present invention relates to a process for the preparation of polysuccinimide and polysuccinimide copolymers, in the absence of aspartamide, by end-capping polymerization, wherein said polymerization is the absence of an amine.

2. Discussion of the Related Art

L-Aspartic acid has been produced commercially since the 1980's via immobilized enzyme methods. The L-aspartic acid so produced mainly has been used as a component of the synthetic sweetener, N-aspartylphenylalaninemethyl ester (ASPARTAME®).

In a typical production pathway, a solution of ammonium maleate is converted to fumarate via action of an immobilized enzyme, maleate isomerase, by continuous flow over an immobilized enzyme bed. Next, the solution of ammonium fumarate is treated with ammonia also by continuous flow of the solution over a bed of the immobilized enzyme, aspartase. A relatively concentrated solution of ammonium asparate is produced, which then is treated with an acid, for example nitric acid, to precipitate L-aspartic acid. After drying, the resultant product of the process is powdered or crystalline L-aspartic acid. Prior art that exemplifies this production pathway includes U.S. Pat. No. 4,560,653 to Sherwin and Blouin (1985), U.S. Pat. No. 5,541 to Sakano et al. (1996), and U.S. Pat. No. 5,741,681 to Kato et al. (1998).

In addition, non-enzymatic, chemical routes to D,L aspartic acid via treatment of maleic acid, fumaric acid, or their mixtures with ammonia at elevated temperature have been known for over 150 years (see Harada, K., Polycondensation of thermal precursors ofaspartic acid. Journal of Organic Chemistry 24, 1662-1666 (1959); also, U.S. Pat. No. 5,872,285 to Mazo et al. (1999)). Although the non-enzymatic routines are significantly less quantitative than the enzymatic syntheses of aspartic acid, possibilities of continuous processes and recycling of reactants and by-products via chemical routes are envisioned.

Polymerization and copolymerization of L-aspartic acid alone or with other comonomers is known. As reviewed in U.S. Pat. No. 5,981,691 to Sikes (1999), synthetic work with polyamino acids, beginning with the homopolymer of L-aspartic acid, dates to the mid 1800's and has continued to the present. Interest in polyaspartates and related molecules increased in the mid 1980's as awareness of the commercial potential of these molecules grew. Particular attention has been paid to biodegradable and environmentally compatible polyaspartates for commodity uses such as detergent additives and superabsorbent materials in disposable diapers, although numerous other uses have been contemplated, ranging from water-treatment additives for control of scale and corrosion to anti-tartar agents in toothpastes.

There have been some teachings of producing copolymers of succinimide and L-aspartic acid or aspartate via thermal polymerization of maleic acid plus ammonia or ammonia compounds. For example, U.S. Pat. No. 5,548,036 to Kroner et al. (1996) taught that polymerization at less than 140° C. resulted in aspartic acid residue-containing polysuccinimides. However, the reason that some aspartic acid residues persisted in the product polymers was that the temperatures of polymerization were too low to drive the reaction to completion, leading to inefficient processes.

JP 8277329 (1996) to Tomida exemplified the thermal polymerization of potassium asparate in the presence of 5 mole % and 30 mole % phosphoric acid. The purpose of the phosphoric acid was stated to serve as a catalyst so that molecules of higher molecular weight might be produced. However, the products of the reaction were of a lower molecular weight than were produced in the absence of the phosphoric acid, indicating that there was no catalytic effect. There was no mention of producing copolymers of aspartate and succinimide; rather, there was mention of producing only homopolymers of polyaspartate. In fact, addition of phosphoric acid in this fashion to form a slurry or intimate mixture with the powder of potassium aspartate, is actually counterproductive to formation of copolymers containing succinimide and aspartic acid residue units, or to formation of the condensation amide bonds of the polymers in general. That is, although the phosphoric acid may act to generate some fraction of residues as aspartic acid, it also results in the occurrence of substantial amounts of phosphate anion in the slurry of mixture. Upon drying to form the salt of the intimate mixture, such anions bind jonically with the positively charged amine groups of aspartic acid and aspartate residues, blocking them from the polymerization reaction, thus resulting in polymers of lower molecular weight in lower yield.

Earlier, U.S. Pat. No. 5,371,180 to Groth et al. (1994) had demonstrated production of copolymers of succinimide and aspartate by thermal treatment of maleic acid plus ammonium compounds in the presence of alkaline carbonates. The invention involved an alkaline, ring-opening environment of polymerization such that some of the polymeric succinimide residues would be converted to the ring-opened, aspartate form. For this reason, only alkaline carbonates were taught and there was no mention of cations functioning themselves in any way to prevent imide formation.

U.S. Pat. No. 5,936,121 to Gelosa et al. (1999) taught formation of oligomers (Mw<1000) of aspartate having chain-terminating residues of unsaturated dicarboxylic compounds such as maleic and acrylic acids. These aspartic-rich compounds were formed via thermal condensation of mixtures of sodium salts of maleic acid plus ammonium/sodium maleic salts that were dried from solutions of ammonium maleate to which NaOH had been added. They were producing compounds to sequester alkaline-earth metals. In addition, the compounds were shown to be non-toxic and biodegradable by virtue of their aspartic acid composition. Moreover, the compounds retained their biodegradability by virtue of their very low Mw, notwithstanding the presence of the chain-terminating residues, which when polymerized with themselves to sizes about the oligomeric size, resulted in non-degradable polymers.

A number of reports and patents in the area of polyaspartics (i.e., poly(aspartic acid) or polyaspartate), polysuccinimides, and their derivatives have appeared more recently. Notable among these, for example, a method for using amines during the polycondensation of DL-aspartic acid is described by Jordan et al. in U.S. Pat. No. 6,933,269 (2005). A multicomponent copolymer of a polyaspartate derivative comprising aspartamide, succinimide and/or aspartate repeat units is produced which can then be incorporated into a laundry detergent composition. There have been disclosures of novel superabsorbents (U.S. Pat. No. 5,955,549 to Chang and Swift, 1999; U.S. Pat. No. 6,027,804 to Chou et al., 2000), dye-leveling agents for textiles (U.S. Pat. No. 5,902,357 to Riegels et al., 1999), and solvent-free synthesis of sulfhydryl-containing corrosion and scale inhibitors (EP 0 980 883 to Oda, 2000). There also has been teaching of dye-transfer inhibitors prepared by nucleophilic addition of amino compounds to polysuccinimide suspended in water (U.S. Pat. No. 5,639,832 to Kroner et al., 1997), which reactions are inefficient due to the marked insolubility of polysuccinimide in water.

U.S. Pat. No. 5,981,691 purportedly introduced the concept of mixed amide-imide, water-soluble copolymers of aspartate and succinimide for a variety of uses. The concept therein was that a monocationic salt of aspartate when formed into a dry mixture with aspartic acid could be thermally polymerized to produce the water-soluble copoly(aspartate, succinimide). The theory was that the aspartic acid comonomer when polymerized led to succinimide residues in the product polymer and the monosodium aspartate comonomer led to aspartate residues in the product polymer. It was not recognized that merely providing the comonomers was not sufficient to obtain true copolymers and that certain other conditions were necessary to avoid obtaining primarily mixtures of polyaspartate and polysuccinimide copolymers. In U.S. Pat. No. 5,981,691, the comonomeric mixtures were formed from an aqueous slurry of aspartic acid, adjusted to specific values of pH, followed by drying. There was no teaching of use of solutions of ammonium aspartate or any other decomposable cation plus NaOH, or other forms of sodium or other cations, for generation of comonomeric compositions of aspartic acid and salts of aspartate. Thus, although some of the U.S. Pat. No. 5,981,691 examples obtain products containing some copolymer in mixture with other products, particularly homopolymers, as discussed in the Summary of the Invention below, the theory that true copolymers could be obtained merely by providing the comonomers in the manner taught in U.S. Pat. No. 5,981,691 was not fully realized.

Thus, to date, there have been no successful disclosures of water-soluble or wetable, mixed amide/imide polyamino acids such as copolymers of aspartate and succinimide, related imide-containing polyamino acids, polysuccinimide or derivatives thereof.

### SUMMARY OF THE INVENTION

One aspect of the present invention relates to a polymerization of L-aspartic acid, in the presence of an end capping initiator, such as an anhydride, a carboxylic acid, or an ester to form a polysuccinimide copolymer. In another aspect the polymerization, in the presence of an end capping initiator, is carried out in a solution, a supercritical fluid, in the molten phase or in the solid phase. Further, another aspect of the present invention allows the introduction of a specific end functionality into the polymer. In another aspect of the present invention the polymerization forms a prepolymer which is subsequently further polymerized by a thermal method or in a supercritical fluid as will become apparent from the discussion that follows. Conversely, the end capping of the monomeric L-aspartic acid at the nitrogen function may precede copolymerization. Dewatering or concentration of monomers may be done by any suitable technique including wiping film evaporator, drum drying, evaporation in a screw reactor or inline concentrator, etc. In an additional embodiment the polysuccinimide formed by end capping initiation is hydrolyzed to form polyaspartate.

### BRIEF DESCRIPTION OF THE DRAWING

FIG. 1 depicts a diagram of a typical extrusion machine. The injection port allows the introduction of reactants into the injection machine for post reactions of the polymer or copolymers in the melt. The sections of the screw are separately heated and interchangeable. Thus, the injection port can be placed downstream in the injection machine depending on the required residence time required for a desired reaction.

### DESCRIPTION OF THE PREFERRED EMBODIMENTS

These previous references do not teach a method whereby a polysuccinimide or a copolymer containing succinimide moieties is formed having a specific end functionality. The end capping polymerization may be used to introduce unique terminal groups with special properties.

A. Thermal Synthesis of Copoly(succinimide-aspartate)

A method has now been discovered providing a sufficiently intimate mixture of the comonomers and, therefore, allowing the production of a true copolymer with a significant number of both aspartate (also referred to as amide) residues or units and succinimide (also referred to as imide) residues or units, as schematically shown by the following reaction:

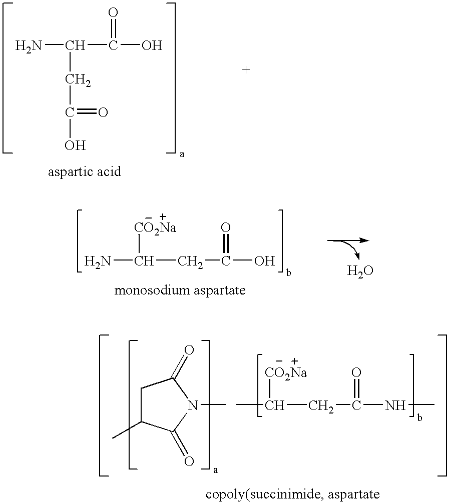

The invention also can provide the resulting copolymers in isolated form. By isolated form it is meant that the copolymer is either: (a) in the substantial absence, e.g., less than 10%, preferably less than 5%, more particularly less than 1%, by weight of a polyaspartate or polysuccinimide homopolymer, (b) prepared by a method defined by this invention or (c) polyaspartate and/or polysuccinimide homopolymer from the copolymer.

Accordingly, the present invention teaches novel methods for producing mixed amide/imide copolymers of amino acids, esters, if hydroxyl acids are included in the feed as comonomers, as well as the resulting novel imide-containing polyamino acids themselves. Included are methods employing the monomers aspartic acid or aspartate salts having non-volatile or non-heat-decomposable cations. By aspartate or aspartate salt is meant a salt of the aspartate ion and any metallic cation, including alkali metal, alkaline earth metals or transition metals. Preferably the cations are alkali or alkaline earth metals, particularly Na, Mg, K, Ca, Rb, Sr, Cs and Ba, with sodium, magnesium, potassium and calcium, particularly sodium, being preferred. These monomers lead to amide formation. Other monomers, particularly aspartates having a volatile or heat-decomposable cation, preferably an ammonium or amine cation, lead to imide formation. In the following, the amide-generating cation will be represented by sodium (Na⁺) and the imide-generating cation will be represented by ammonium (NH₄⁺) but with the understanding that other cations creating the same effects for achieving the invention may be substituted. By volatile or heat-decomposable cation it is meant that the cation sufficiently dissociates from the aspartate anion under the given drying conditions such that the remaining aspartate unit can cyclize to a succinimide unit during the polymerization. Cations which have at least 50% dissociation in this manner under the given drying conditions are considered volatile or heat-decomposable and cations which do not dissociate at least 50% are considered non-volatile or non-heat decomposable. Preferably, the aspartic acid of the present invention is L-aspartic acid.

In the present invention, some elements of the conventional, enzymatic processes for production of aspartic acid can be adapted for producing monomers useful in the invention. The production of the comonomer mixture, however, is a novel aspect. The method involves providing an intimate solution of an aspartate of a non-volatile cation and an aspartate of a volatile cation. By the term aspartate is meant an aspartic acid residue, either as a monomer or as a polymerized or copolymerized unit having its carboxyl group in ionic form associated with a cation, i.e., as —COO⁻. Specifically, for example, an ammonium aspartate solution can be titrated with NaOH to a fractional molar equivalence of a sodium salt of aspartate and an ammonium salt of aspartate. This comonomeric solution is then dried to produce a comonomer mixture of a partial sodium salt of aspartic acid and free aspartic acid. By free aspartic acid is meant aspartic acid or a polymerized or copolymerized aspartic acid residue having its carboxyl group not in ionic form, i.e., —COOH. Because the dried comonomer mixture is prepared from the novel intimate solution of comonomers, an intimate dried mixture of these comonomers is obtained. Although not intending to be bound by this theory, it is believed that the mixture is intimate to the extent of exhibiting a salt lattice structure of the aspartate with the aspartic acid. It is possible for the dried comonomeric composition to also contain some residual ammonium aspartate, but in very small amounts, e.g., not exceeding 5% by weight, preferably not exceeding 2% by weight.

In effect, the aspartate of the volatile cation (e.g. ammonium) when dried from aqueous solution, is largely converted to powdered or crystalline aspartic acid. This is due to the loss of the decomposable cation, e.g., ammonia, as a vapor upon drying, with accompanying lowering of the pH of the evaporating solution as ammonia leaves the solution, for example, as a result of the following equilibrium being pulled to the left:
↑NH₃⇄NH₃+H₂O⇄NH₄OH⇄NH₄⁺+OH⁻.

The sodium ion, on the other hand, has no significant vapor phase during drying and remains in the dried salt as a counter ion to aspartate monomers. Thus, the relative proportions of the comonomers, monosodium aspartate and aspartic acid, is set by the relative molar amounts of ammonium aspartate in solution and the NaOH added to the solution prior to drying.

The dried comonomer mixture is a clear, glassy solid if drying occurs in vacuo or in an oxygen-depleted atmosphere. In the presence of atmospheric oxygen, the dried comonomer preparation has a pale yellow, glassy appearance.

The comonomer composition of the present invention may also be prepared via non-enzymatic, chemical production of solutions of ammonium aspartate. For example, maleic acid plus ammonia in water plus heating, preferably at an elevated pressure, may produce ammonium aspartate in solution. Typically, temperatures of 80 to 160° C., preferably 120 to 160° C. and a pressure of up to about 120 psi can be used, although other conditions may be useful depending on the particular circumstances. Upon addition of the desired amount of NaOH, this solution is dried to form the comonomer composition containing the mixture of the sodium aspartate salt and aspartic acid.

The comonomeric composition may also be obtained via coprecipitation from solution. For example, addition of a hydrophobe or downward adjustment of pH may lead to coprecipitation of the monomers. These may then be isolated, for example by filtration, for use in the production of the imide-containing polymers.

Additional preferred comonomers include but are not limited to arginine and asparagine, which is inherently present in the product, in accordance with the present invention, in an amount of from 0 to 15%; and cystine, which preferably forms a disulfide which can be further subjected to reductive cleavage to yield two mercaptans, which mercaptans are available for further derivatization or oxidative cleavage to form a sulfonate. Further, additional comonomers include but are not limited to chitin and chitosan, at a weight average molecular weight ranging from an oligomer to 1,000,000 including all increments within the above range. The term “oligomer” as used in the present application denotes a resin with a degree of polymerization (DP) between 10 and 100. Further comonomers include but are not limited to a polysaccharide ranging in weight average molecular weight from that of an oligomer to that of a naturally occurring polysaccharide, including all increments within the above range.

Also included are methods in which maleic acid plus ammonia plus soluble, non-alkali as well as alkali, cationic salts are used to internally generate a combination of aspartic acid and monosodium aspartate comonomers for thermal polymerization to produce water-soluble, imide containing copolymers.

In another aspect of the present invention, instead of monomers, a prepolymer is used formed in an end capping polymerization as described below.

In another embodiment, the copolymer formed in the thermal polymerization is further reacted with an end capping initiator, as described below, to increase the molecular weight or introduce end functionality to the final product.

In another embodiment of the present invention, the polymerization in accordance with the present invention is carried out in the presence of a thermal stabilizer or an antioxidant or a mixture thereof as discussed below.

B. Formation of Polysuccinimide in the Presence of an End capping Polymerization Initiator

In a further embodiment of the present invention a polymeric material containing succinimide or aspartate moieties is formed by end capping polymerization. The term “polymeric material containing succinimide or aspartate moieties” is used herein to denote a polysuccinimide, a polyaspartate, an oligomer containing succinimide or aspartate moieties or a prepolymer containing succinimide or aspartate moieties in the absence of an aspartamide. The term “oligomer” as used in the present application denotes a polymeric material with a degree of polymerization (DP) between 10 and 100. The term “prepolymer” is used herein to denote a polymeric material with low molecular weight, preferably from 100 to 1,000 weight average molecular weight (Mw). The term “end capping” is used in the present application to denote the initiation of chain growth polymerization. An end capping initiator in accordance with the present invention is represented by an anhydride of formula (A), an acid of formula (B) or an ester of formula (C) below: 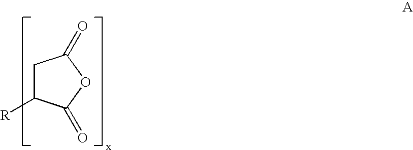
R(CO₂H)ₓ (B); R(CO₂R₁)ₓ (C)
where x is an integer from 1 to 2000, including any integers within this range, preferably from 1 to 100, more preferably from 1 to 10, most preferably from 1 to 5; R and R₁, are the same or different radicals selected from the group consisting of hydrogen, an alkyl, such as methyl, ethyl, n-propyl, isopropyl, n-butyl, isobutyl, sec-butyl, n-amyl, isoamyl, n-hexyl, n-octyl, capril, n-decyl, lauryl, myristyl, cetyl, and stearyl; substituted alkyl, such as hydroxyethyl, polyoxyalkyl; alkenyl, such as allyl; azyl, such as phenyl, naphthyl; aryl-alkyl, such as benzyl; or substitute aryl radical, such as alkylphenyl, chlorophenyl and nitrophenyl. Further, R may also contain a functional group (radical), provided the functional group on R does not react with another functional group on the same molecule. In other words, R in formula (A) cannot contain an amine functional group that would react with the anhydride on the same molecule.

Accordingly, when x is 1, a linear copolysuccinimide or polyaspartate is formed; when x is 2, a linear copolysuccinimide or polyaspartate is also formed, however, the molecular weight of the copolysuccinimide or polyaspartate builds up from both functional groups of the end capping initiator; further, when x is 3 or higher, a star copolysuccinimide or polyaspartate is formed as a result of the initiation of polymer chains from all functional groups present on the end capping initiator. The end-capping initiator in accordance with the present invention is in the absence of an amine.

The aspartic acid or aspartate salt is dried as described under Section A of the present specification for Thermal Synthesis of Poly(succinimide-aspartate) except that the aspartic acid is mixed with an end capping initiator prior to drying. The polymerization proceeds by subjecting the mixture in solid phase polymerization, melt polymerization in an extruder as described below, in a rotary evaporator, in dispersion or solution in oil, in phosphoric acid in the absence of a salt, in supercritical fluids or any other method. If the monomer is aspartic acid polysuccinimide is formed; additional comonomers may be present, as discussed under the thermal process above.

An end capping initiator with at least one carboxyl group will react with the amine functionality of the aspartic acid and the final product will be in the absence of any amine functionality. Further, polymeric end capping initiators, in other words end capping initiators with a polymeric backbone and containing at least one functionality such as a carboxy or an anhydride or an ester, are within the scope of the present invention.

Non binding examples are shown below using an anhydride, such as succinic anhydride, as shown in Reaction 1, and an acid, such as succinic acid, as shown in Reaction 2 to form polysuccinimide:

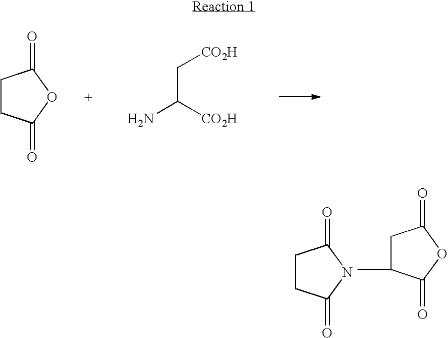

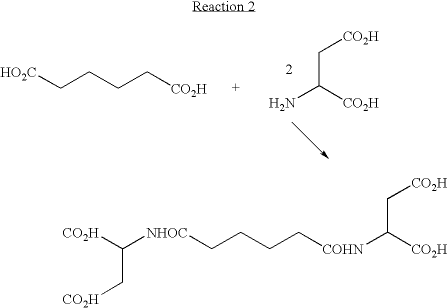

Thus, the anhydride reacts with the amino group of the L-aspartic acid to form an amide bond which then cyclizes to form the succinimide moiety. Meanwhile the carboxyl group of the L-aspartic acid reacts with the amino group of another L-aspartic acid, to build up the chain length of copolysuccinimide or polyaspartate, and then cyclizes. This proceeds until the L-aspartic acid is used up. In the case where the L-aspartic acid is the final group, the carboxyl groups cyclize to form the anhydride. Thus, in an additional embodiment of the present application a polyanhydride is formed, wherein the term “polyanhydride” is used to denote a polymer containing two or more anhydride moieties.

Suitable end capping initiators used to initiate polymerizations containing chosen end groups in accordance with the present invention, include but are not limited to an anhydride such as succinic anhydride; phthalic anhydride; maleic anhydride; itaconic anhydride, alkenyl succinic anhydride, which leaves a hydrocarbon chain with a double bond; 1,2,4-benzenetricarboxylic anhydride; cis-1,2,3,6-tetrahydrophthalic anhydride; 1,2-cyclohexane dicarboxylic anhydride; or a carboxylic acid, such as an acid of the general formula: CH₃(CH₂)ₙCOOH, where n is from 0 to 16; a dibasic acid of the general formula: HOOC(CH₂)ₙCOOH, where n is from 4 to 16; particular examples of acids include but are not limited to oxalic acid; benzoic acid; thiolsuccinic acid, which would leave a thiol end group; terephthalic acid; succinic acid; phthalic acid; maleic acid; itaconic acid, lactic acid, malic acid; alkenyl succinic acid; 1,2,4-benzenetricarboxylic acid; cis-1,2,3,6-tetrahydrophthalic acid; and 1,2-cyclohexane dicafboxylic acid, adipic acid and azelaic acid, as well as esters of the above acids. From the known concentration of the initiator the molecular weight of the chain, that is the chain length, can be controlled by controlling the amount of the monomers used. Additional examples include polymeric materials containing at least one pendant carboxyl functionality or at least one pendant anhydride functionality, such as an acrylate copolymer containing an acrylic, methacrylic or itaconic acid moiety, or a polymer containing a maleic anhydride moiety, such as styrene-maleic anhydride copolymer (SMA).

Additional suitable nucleophiles include but are not limited to a poly(vinyl alcohol); a polyester; a polyamide; a polysaccharide, such as starch; a dextran; and a cellulose; a protein; a dye; and a UV absorber. The anhydride reacts considerably faster than the succinimide moieties within the chain. Also included are polymeric materials containing at least one functionality selected from an anhydride, carboxylic acid or ester functionality, such as styrene-maleic anhydride copolymer. Preferably the polymeric materials containing at least one functionality exhibit a (Mw) weight average molecular weight higher than 1,000, more preferably from 2,000 to 5,000, including all increments within this range.

Thus, in an embodiment in accordance with the present invention, the polymer formed by end capping initiation contains a specific chain end functionality, introduced to the polymer by the choice of the end capping initiator.

In another embodiment the polymerization in the presence of the end capping initiator is carried out in a solvent, such as water, in a supercritical fluid, in the molten phase or in the solid phase.

In another embodiment of the present invention a prepolymer is formed. The term “prepolymer” is used herein to denote a polymer with low molecular weight, preferably from 100 to 1,000 weight average molecular weight. Subsequently the polymerization proceeds in the absence of the end capping initiator as described above in the thermal and supercritical fluid polymerizations, or in the molten phase or in the solid phase.

An advantage of this approach is that the end capping reaction improves significantly the color of the final product. Although Applicants do not wish to be bound to any theories, they believe that this is due to the fact that the process is not on the basic side and the amine groups are tied up rapidly. Interestingly, it has been found that the color gets better as the ratio of the end capping chain initiator (CI) to L-aspartic acid (AA), CI:AA, increases. The ratio of the end capping initiator to polymerizing L-aspartic acid controls the Mw of the polymer formed. Accordingly, preferred ratios depend on the desired Mw of the polymer formed. Preferred ratios include but are not limited to, from 1:1 to 1:1000 including all ratios within this range, such as from 1:1 to 1:100, from 1:1 to 1:10, or from 1:1 to 1:5.

In another embodiment by properly controlling the ratio of CI:AA discussed above as well as the chain initiating group a material is formed in the molten state at the reaction temperature which is amenable to processing via extrusion, as described below.

Another advantage lies in the anhydride end of the chain in that further reaction can be initiated from that end. For example, other monomers can be used to build chains exhibiting greater flexibility, hydrophobicity or a specific hydrophobic/hydrophilic value. In one of the embodiments a block copolymer is formed in this manner.

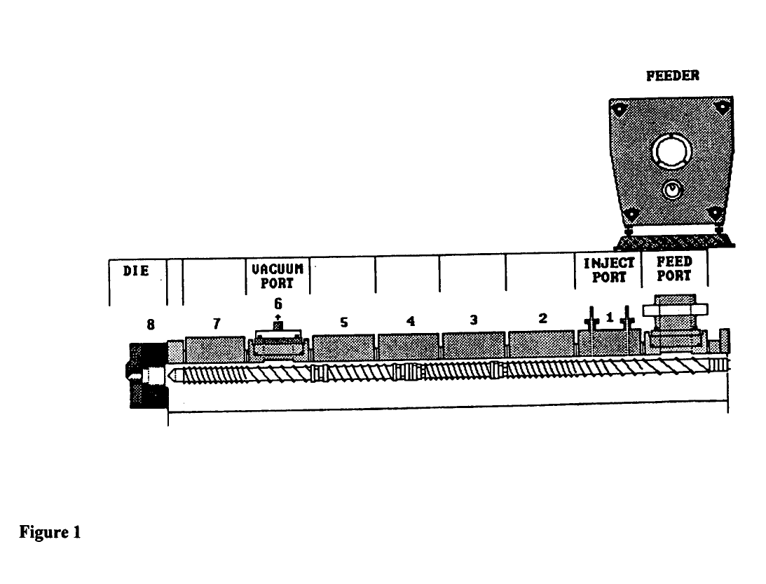

In another embodiment in accordance with the present invention an oligomer is formed in an extruder and subsequently an additional monomer or mixture of monomers is introduced in the extruder through an injection port as shown in FIG. 1. One can envision the preparation of numerous products, with controlled weight average molecular weight (Mw) ranging from 1,000 to 500,000, including all increments within that range, preferably from 1,000 to 50,000, more preferably from 2,000 to 10,000 Daltons, in one continuous process. As pointed out above, the ratio of the end capping initiator to polymerizing monomer(s) controls the Mw of the polymer.

The rheology of the starting materials in the extruder, in accordance with the present invention, is a function of the end group, type of comonomer and molecular weight of comonomer. Comonomers with plasticizing effect are useful in reducing the rheology and improving processability.

Additional suitable monomers which can be used to chain extend, besides L-aspartic acid, include but are not limited to a dicarboxy amino acid, a hydroxy acid, and combinations of a diol with a dicarboxylate to form a polyester.

Additional monomers or comonomers in accordance with the present invention include but are not limited to glutamic acid and γ-methylene glutamic acid.

Proper control of the molecular weight and the functionalities result in dispersants, surface active agents, rheology modifiers, thickeners, corrosion inhibitors, sun screens, gels in water or in solvents, etc.

Preferably the end capping reaction is carried out in the presence of a catalyst. Suitable catalysts include but are not limited to a protonic acid, such as polyphosphoric acid; a Lewis acid; an organometallic catalyst, preferably one of those used for condensation reactions, such as tin octanoate.

In another embodiment of the present invention the end capping reaction is initiated via the amino group in the presence of a primary or secondary amine.

In another embodiment the resin formed in accordance with the present invention is stabilized with polymer additives before or after isolation. Polymer additives are discussed in the Modern Plastics Encyclopedia, A Division of McGraw Hill Companies, 72, pages C-3 to C-117 (1995) and in Kirk-Othmer Concise Encyclopedia of Chemical Technology, John Wiley & Sons, New York, pages 129-130 (1985), both of which are incorporated herein by reference.

In another embodiment of the present invention, the preparation of a derivative in accordance with the present invention is carried out in the presence of a thermal stabilizer or an antioxidant or a mixture thereof as discussed below.

C. A Polyamide in the Absence of Succinimide or Aspartate Moieties formed in the Presence of an End capping Polymerization Initiator

In a further embodiment of the present invention a polymeric material containing imide moieties is formed by end capping polymerization. The term “polymeric material containing imide moieties” is used herein to denote a (co)polyimide, an oligomer containing imide moieties, or a prepolymer containing imide moieties. The term “(co)polyimide” is used to denote a homopolymer or copolymer containing imide moieties. The term “oligomer” as used in the present application denotes a polymeric material with a degree of polymerization (DP) between 10 and 100. The term “prepolymer” is used herein to denote a polymeric material with low molecular weight, preferably from 100 to 1,000 weight average molecular weight (Mw). The term “end capping” is used in the present application to denote the initiation of chain growth polymerization. An end capping initiator in accordance with the present invention is an anhydride represented by an acid anhydride, in the absence of a maleic anhydride moiety, of formula (A), a carboxylic acid represented by formula (B) or an ester represented by formula (C) as described above, except in the absence of succinic anhydride, where x is an integer from 1 to 2,000, including all increments within this range, preferably from 1 to 1,000, more preferably from 1 to 100, most preferably from 1 to 10; included in the preferred ranges are from 1 to 5 and from 1 to 3; R, and R₁ are the same or different radicals selected from the group consisting of hydrogen, an alkyl, such as methyl, ethyl, n-propyl, isopropyl, n-butyl, isobutyl, sec-butyl, n-amyl, isoamyl, n-hexyl, n-octyl, capril, n-decyl, lauryl, myristyl, cetyl, and stearyl; substituted alkyl, such as hydroxyethyl, polyoxyalkyl; alkenyl, such as allyl; aryl, such as phenyl, naphthyl; aryl-alkyl, such as benzyl; or substitute aryl radical, such as alkylphenyl, chlorophenyl and nitrophenyl. Further, R may also contain a functional group, provided the functional group on R does not react with another functional group on the same molecule. In other words, R in formula (A) cannot contain an amine functional group that would react with the anhydride on the same molecule.

Accordingly, when x is 1, a linear copolyimide is formed; when x is 2, a linear copolyimide is also formed; however, the molecular weight of the copolyimide builds up from both functional groups of the end capping initiator; further, when x is 3 or higher, a star copolyimide is formed as a result of the initiation of polymer chains from all functional groups present on the end capping initiator. The term “(co)polyimide” is used herein to denote a homopolymer or a copolymer containing imide moieties. When one amino acid is present in the polymerization, the product is a homopolymer; when more than one amino acid is present during the polymerization, the product is a copolymer.

The amino acid is dried as described under Section A of the present specification for Thermal Synthesis of Poly(succinimide-aspartate) except that an amino acid, other than L-aspartic acid, is mixed with an end capping initiator prior to drying. The polymerization proceeds by subjecting the mixture in solid phase polymerization, melt polymerization in an extruder as described below, in a rotary evaporator, in dispersion or solution in oil, in phosphoric acid in the absence of a salt, in a supercritical fluid or any other method.

An end capping initiator with at least one carboxyl group will react with the amine functionality of the amino acid, and the final product will be in the absence of any amine functionality. Further, polymeric end capping initiators, in other words, end capping initiators with a polymeric backbone and containing at least one functional group selected from a carboxy, an ester or anhydride, are within the scope of the present invention.

Non binding examples are shown below using an anhydride, such as maleic anhydride, as shown in Reaction 1, and an acid, such as fumaric acid, as shown in Reaction 2 to form a homopolymer containing glutaric imide moieties:

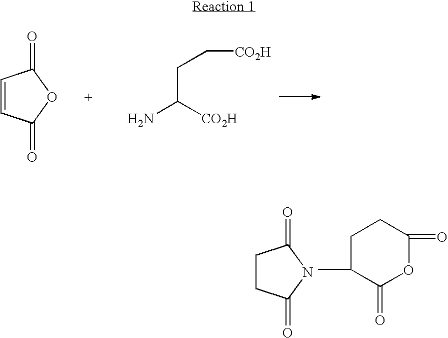

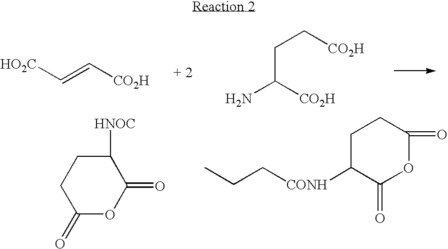

Thus, in the example, Reaction 1 above, the maleic anhydride reacts with the amino group of the glutamic acid to form an imide bond and the cyclic anhydride of glutamic acid. Further, the anhydride of glutamic acid reacts with the amino group of another glutamic acid to form a glutarimide. Reactions with additional glutamic acid molecules build up the chain length of glutarimide. This proceeds until the glutamic is used up.

Suitable end capping initiators used to initiate polymerizations containing chosen end groups in accordance with the present invention, include but are not limited to an anhydride such as; phthalic anhydride; maleic anhydride; itaconic anhydride; 1,2,4-benzenetricarboxylic anhydride; cis-1,2,3,6-tetrahydrophthalic anhydride; 1,2-cyclohexane dicarboxylic anhydride; or a carboxylic acid, such as HCOOH or an acid of the general formula: CH₃(CH₂)ₙCOOH, where n is from 0 to 16; a dibasic acid of the general formula: HOOC(CH₂)ₙCOOH, where n is from 4 to 16; particular examples of acids include but are not limited to maleic acid, fumaric acid, oxalic acid, benzoic acid, terephthalic acid, phthalic acid, itaconic acid, 1,2,4-benzeneticarboxylic acid, cis-1,2,3,6-tetrahydrophthalic acid, 1,2-cyclohexane dicarboxylic acid, adipic acid, lactic acid, malic acid and azelaic acid, as well as esters of the above acids. From the known concentration of the initiator the molecular weight of the chain, that is the chain length, can be controlled by controlling the amount of the monomers used.

In a further embodiment the anhydride end group of an end capping initiator is reacted with a hydroxyl terminated material. Additional suitable nucleophiles include but are not limited to a poly(vinyl alcohol); a polyester; a polyamide; a polysaccharide, such as starch; a dextran; and a cellulose; a protein; a dye; and a UV absorber. The anhydride reacts considerably faster than the succinimide moieties within the chain. Also included are polymeric materials containing at least one functionality selected from an anhydride, a carboxylic acid or ester functionality, such as a styrene-maleic anhydride copolymer.

Preferably the polymeric materials containing at least one functionality exhibit a weight average molecular weight (Mw) higher than 1,000, more preferably from 2,000 to 50,000, including all increments within this range.

Thus, in an embodiment in accordance with the present invention, the polymer formed by end capping initiation contains a specific chain end functionality, introduced to the polymer by the choice of the end capping initiator.

In another embodiment the polymerization in the presence of the end capping initiator is carried out in a solvent, such as water, or in a supercritical fluid, or in the molten phase or in the solid phase.

In another embodiment of the present invention a prepolymer is formed. The term “prepolymer” is used herein to denote a polymer with low molecular weight, preferably from 100 to 1,000 weight average molecular weight (Mw). Subsequently the polymerization proceeds in the absence of the end capping initiator as described above in the thermal and supercritical fluid polymerizations, or in the molten phase or in the solid phase.

An advantage of this approach is that the end capping reaction using an anhydride, an acid or an ester improves significantly the color of the final product. Although Applicants do not wish to be bound to any theories, they believe that this is due to the fact that the process is not on the basic side and the amine groups are tied up rapidly. Interestingly, it has been found that the color gets better as the ratio of the end capping chain initiator (CD) to L-aspartic acid (AA), CI:AA, increases from 1:100 to 1:1,000, preferably from 1:10 to 1:100, more preferably from 1:1 to 1:10, most preferably from 1:1 to 1:5.

In another embodiment by properly controlling the ratio of CI:AA discussed above as well as the chain initiating group a material is formed in the molten state at the reaction temperature which is amenable to processing via extrusion, as described below.

Another advantage lies in the anhydride end of the chain in that further reaction can be initiated from that end. For example, other monomers can be used to build chains exhibiting greater flexibility, hydrophobicity or a specific hydrophobic/hydrophilic value. In one of the embodiments a block copolymer is formed in this manner.

In another embodiment in accordance with the present invention an oligomer is formed in an extruder and subsequently an additional monomer or mixture of monomers is introduced in the extruder through an injection port as shown in FIG. 1. One can envision the preparation of numerous products, with controlled weight average molecular weight (Mw) ranging from 1,000 to 500,000, including all increments within that range, preferably, from 1,000 to 50,000, more preferably from 2,000 to 10,000 Daltons, in one continuous process. The ratio of the end capping initiator to polymerizing monomer(s) controls the Mw of the polymer.

Suitable monomers or comonomers in accordance with the present invention include but are not limited to dicarboxy amino acids, such as L-aspartic acid, glutarnic acid and γ-methylene glutamic acid.

Additional comonomers described above under the thermal processing may also be used in accordance with this embodiment.

In a further embodiment the anhydride end group is reacted with a hydroxyl terminated material. Additional suitable nucleophiles include but are not limited to a poly(vinyl alcohol); a polyester; a polyamide; a polysaccharide, such as starch; a dextran; and a cellulose; a protein; a dye; and a UV absorber. The anhydride reacts considerably faster than the succinimide moieties within the chain.

In an additional embodiment the imide moieties react with a hydroxyl terminated material to form a graft copolymer, such as a comb-graft copolymer or a copolymer having a hyperbranched structure.

Proper control of the molecular weight and the functionalities result in dispersants, surface active agents, rheology modifiers, thickeners, corrosion inhibitors, sun screens, gels in water or in solvents, etc.

Preferably the end capping reaction is carried out in the presence of a catalyst. Suitable catalysts include but are not limited to a protonic acid, such as polyphosphoric acid; a Lewis acid; an organometallic catalyst, preferably one of those used for condensation reactions, such as tin octanoate.

In another embodiment of the present invention the end capping reaction is initiated via the amino group in the presence of a primary or secondary amine.

In another embodiment the resin formed in accordance with the present invention is stabilized with polymer additives before or after isolation. Polymer additives are discussed in the Modern Plastics Encyclopedia, A Division of McGraw Hill Companies, 72, pages C-3 to C-117 (1995) and in Kirk-Othmer Concise Encyclopedia of Chemical Technology, John Wiley & Sons, New York, pages 129-130 (1985), both of which are incorporated herein by reference.

D. Synthesis of Polysuccinimide in a Supercritical Fluid in the Presence of an End Capping Initiator

In another embodiment of the present invention polysuccinimide or polyaspartate is synthesized in a supercritical fluid at high molecular weight and high yield. In accordance with this embodiment, a dicarboxylic amino acid, such as L-aspartic acid is prepared in a similar manner to that discussed in the thermal synthesis of copoly(succinimide-aspartate) above except that the dicarboxylic amino acid is mixed with an end capping initiator. This mixture is then subjected to polymerization in a supercritical fluid in a method similar to that described for the synthesis of polysuccinimide above. The weight average molecular weight is in the order of about 1,000 to 200,000 Dalton, preferably 5,000 to about 150,000, more preferably between 5,000 and 100,000 Daltons including all increments within that range, and most preferably in the range of from 5,000 to 10,000 Daltons.

A supercritical fluid is a fluid medium that is at a temperature that is sufficiently high that it cannot be liquified by pressure. A supercritical fluid relates to dense gas solutions with enhanced solvation powers, and can include near supercritical fluids. The basis for a supercritical fluid is that at a critical temperature and pressure, the liquid and gas phases of a single substance can co-exist.

Further, supercritical fluids are unique states of matter existing above certain temperatures and pressures. As such, these fluids exhibit a high level of functionality and controllability that can influence not only the macrophysical properties of the fluid, but also influence nano-structures of molecules dissolved in them.

The supercritical fluid phenomenon is documented, for example, in the CRC Handbook of Chemistry and Physics, 67th Edition, pages F-62 to F-64 (1986-1987), published by the CRC Press, Inc., Boca Raton, Fla. At high pressures above the critical point, the resulting supercritical fluid, or “dense gas”, attains densities approaching those of a liquid and assumes some of the properties of a liquid. These properties are dependent upon the fluid composition, temperature, and pressure. As used herein, the “critical point” is the transition point at which the liquid and gaseous states of a substance merge with each other and represents the combination of the critical temperature and critical pressure for a given substance.

The compressibility of supercritical fluids is great just above the critical temperature where small changes in pressure result in large changes in the density of the supercritical fluid. The “liquid-like” behavior of a supercritical fluid at higher pressures results in greatly enhanced solubilizing capabilities compared to those of the “subcritical” compound, with higher diffusion coefficients and an extended useful temperature range compared to liquids. It has also been observed that as the pressure increases in a supercritical fluid, the solubility of the solute often increases by many orders of magnitude with only a small pressure increase.

Near-supercritical liquids also demonstrate solubility characteristics and other pertinent properties similar to those of supercritical fluids. Fluid “modifiers” can often alter supercritical fluid properties significantly, even in relatively low concentrations. In one embodiment, a fluid modifier is added to the supercritical fluid. These variations are considered to be within the concept of a supercritical fluid as used in the context of this invention. Therefore, as used herein, the phrase “supercritical fluid” also denotes a compound above, at, or slightly below the critical temperature and pressure (the critical point) of that compound.

The use of supercritical fluids in the production of polymers as a swelling, foaming or purification agent is known from various sources. Supercritical fluid serves to increase resin mobility thereby improving mixing and processing, to reduce the polymer glass transition temperature by swelling, and enabling processing at lower temperatures, and acts as a solvent for impurities (including unreacted monomer and residual conventional solvents) which may be removed during the processing to give high purity products. Moreover the fluid can be used to aerate the polymer by transition to non-critical gaseous state whereby a porous material may be obtained. Supercritical fluid has found application in incorporation of dyes and other inorganic materials which are insoluble in the supercritical fluid, for example inorganic carbonates and oxides, into polymers with a good dispersion to improve quality, in particular dispersion in products such as paints for spray coating and the like.

Accordingly, in another embodiment of the present invention an additive is dispersed into the copoly(succinimide-aspartate) or a derivative thereof formed in a supercritical fluid.

Examples of compounds which are known to have utility as supercritical fluids are but are not limited to CO₂, NH₃, H₂O, N₂O, xenon, krypton, methane, ethane, ethylene, propane, pentane, methanol, ethanol, isopropanol, isobutanol, CClF₃, CFH₃, cyclohexanol and a mixture thereof.

Due to the low cost, environmental acceptability, non-flammability, and low critical temperature of carbon dioxide, nitrous oxide, and water, supercritical carbon dioxide, nitrous oxide and/or H₂O fluid is preferably employed in the present invention. More preferably carbon dioxide is employed in the present invention.

In another embodiment of the present invention, a cosolvent is preferably used in conjunction with the supercritical fluid as a polymerization vehicle. Suitable cosolvents include but are not limited to trans-2-hexenyl acetate, ethyl trans-3-hexenoate, methyl caproate, isobutyl isobutyrate, butyl acetate, butyl methacrylate, hexyl acetate, butyl butyrate, pentyl propionate, methyl ethanoate, ethyl caproate, methyl dodecanoate, 2-ethylbutyl acetate, methyl oleate, dodecyl acetate, methyl tridecanoate, soybean oil methyl esters, hexane, heptane, tetradecane, hexadecane, toluene, 1-hexadecene, 1-dodecanol, 1-nonanol and a mixture thereof.

The supercritical fluid is preferably maintained at a pressure from about 500 psi to about 2500 psi, more preferably from about 700 psi to about 2000 psi, and at a temperature from about 50° C. to about 300° C., more preferably from about 100° C. to about 250° C. The term “about” is used in the present application to denote a variation of 10% of the stated value.

The weight percentage of cosolvent and solute in the supercritical fluid is preferably from about 1% to about 20%, more preferably from about 5% to about 15%.

The weight average molecular weight of the copoly(succinimide-aspartate) in accordance with the above process is in the order of from about 1,000 to about 10,000 Dalton, including all increments within that range, and preferably in the order of from about 3,000 to about 5,000 Daltons.

In another embodiment of the present invention the polymerization in a supercritical fluid is carried out in the presence of a catalyst, preferably an acidic catalyst, such as phosphoric acid.

In another aspect of the present invention, instead of monomers, a prepolymer is used formed in an end capping polymerization as described below.

In another embodiment, the copolymer formed in the supercritical fluid is further reacted with an end capping initiator, as described below, to increase the molecular weight or introduce end functionality to the final product.

Additional comonomers as described above under thermal process may be used in accordance with this embodiment.

In another embodiment of the present invention, the preparation of a derivative in accordance with the present invention is carried out in the presence of a thermal stabilizer or an antioxidant or a mixture thereof as discussed below.

E. Synthesis of Polyaspartate

In another embodiment in accordance with the present invention the polysuccinimide formed in the method described under sections (B) or (C) above, is hydrolyzed to form a polyaspartate.

F. Polymer Additives

The polymers of the present invention may be mixed (compounded) with a number of additives selected to impart the desired properties to the end product and to facilitate its fabrication. Arriving at a specific complex formulation may be the result of an engineering art and experimentation. Preferred polymer additives include but are not limited to the following:

Stabilizers: During processing a polymer must be brought to the molten state at temperatures much above those of their melting or glass transition. This is done to lower their viscosity and to extend the upper limit of possible processing rates without melt fracture. Consequently there is the real danger of thermal degradation during processing. For this reason heat stabilizers, such as free radical scavengers, maybe used. Polymer chains maybe also sensitive to forms of energy other than thermal. In particular, uses that are intended for outdoor applications must be able to withstand ultraviolet (UV) radiation, for which purpose UV stabilizers are added. In addition the polymer maybe stabilized against oxidative degradation, both short term at elevated processing temperatures, and long term during storage and use. In an oxidative degradation oxygen is absorbed and produces free radicals that react with the chains, usually autocatalytically, and degrade them. Most of the antioxidants combine with the oxygen-generated free radicals and inactivate them.

Antioxidants: Antioxidants are chemical compounds which are incorporated at low concentrations into polymer systems to retard or inhibit polymer oxidation and its resulting degradative effects by atmospheric oxygen. Their use is essential in order to protect the polymer during production, processing, compounding, and end use. Oxidation is a common natural phenomenon which can occur at any phase of a polymer's existence: during polymerization, processing, or end use of the product. The process may cause a variety of chemical and physical changes such as discoloration, loss of gloss or transparency, surface chalking and cracks. Oxidation tends to lower the physical properties of a polymer, such as impact strength, elongation, and tensile strength. The process may continue to degrade a polymer article until it loses its utility. The rate and effects of oxidation differ depending on the polymer, manufacturing process, and morphology.

Auto-oxidation: Organic materials react with molecular oxygen in a process called “auto-oxidation”. Auto-oxidation is a free-radical chain reaction and, therefore, can be inhibited at the initiation and propagation steps. The process is initiated when free alkyl radicals (R-) are generated in the polymer by heat, radiation, stress, or residues. Without the protection afforded by antioxidants, these radicals begin a chain reaction which degrades the polymer.

Although Applicants do not wish to be bound to any particular theory, it is generally believed that polymeric oxidation begins when a free radical containing a highly reactive electron reacts with oxygen forming peroxy radicals (ROO.). These react with the polymer to produce hydroperoxides (ROOH) which decompose further to form two new free radicals. These begin the cycle anew, propagating a cascade of reactions that, sometimes in the absence of an antioxidant, can turn into a chain reaction leading to the failure of the polymer. Antioxidants terminate this sequence and eliminate free radicals from the system.

Stabilization is achieved either by termination reactions or by inhibiting the formation of free radicals. Primary antioxidants increase the number of terminations while secondary antioxidants reduce the formation of free radicals. Primary and secondary antioxidants are often used together with synergistic results.

Primary antioxidants: Primary antioxidants such as hindered phenols and secondary arylamides interrupt free radical processes by donating labile hydrogen atoms to change propagating hydroperoxy radicals into stable species.

Hindered phenols: Hindered phenols interrupt the auto-oxidation cycle. The hindered phenol is capable of donating hydrogen atoms, undergoing rearrangement reactions, and further reacting with free radicals until it is fully consumed. Over-oxidation of the hindered phenol is undesirable since it causes discoloration. Several approaches to stabilization which avoid over-oxidation of the phenolic have been developed. Trivalent phosphorous compounds and antacids (calcium stearate and zinc stearate) to scavenge acidic catalyst residues are typically used as co-additives in combination with the phenolic. Most of the newer commercial antioxidants are of this type, such as alkylated hydroquinones and phenols. In high temperature applications, polynuclear phenols generally are preferred over monophenols because of their lower sublimation rates. Phenolic antioxidants are typically used at levels ranging from 0.05 to 2.0 wt %.

Secondary antioxidants: Secondary antioxidants, such as phosphites or thioesters, are peroxide decomposers that undergo redox reactions with hydroperoxides to form stable products. They are cost effective because they can be substituted for a portion of the more costly primary antioxidant and provide equivalent performance.

Phosphites: Phosphites generally are used in combination with other antioxidants, particularly phenols, the most commonly used secondary antioxidants, reduce hydroperoxides to alcohols. Phosphites are highly effective process stabilizers, non-discoloring, and have broad FDA regulation for many indirect food contact applications. Tri (mixed nonyl- and dinonylphenyl) phosphite is used in the largest volume. Use levels vary from 0.05 to 3.0 wt %.

Thioesters: Thioesters reduce hydroperoxides to alcohols. Thioesters are non-discoloring, FDA regulated, and incorporated to improve long-term heat stability. Typical use levels are from 0.1 to 0.3 wt % in polyolefins with higher levels used in polymers containing unsaturation.

Synergy between primary and secondary antioxidants: Combinations of certain antioxidants sometimes provide synergistic protection. The most common synergistic combinations are mixtures of antioxidants operating by different mechanisms. For example, combinations of peroxide decomposers may be used with propagation inhibitors. Similarly, combinations of metal chelating agents maybe used with propagation inhibitors. Synergistic combinations of structurally similar antioxidants are also known, particularly combinations of phenols.

Blends of a phenolic and a phosphite are very useful for melt compounding. They work well to maintain the molecular weight of the polymer, while at the same time maintaining low color. The phosphite decomposes hydroperoxides and protects the phenolic during processing thereby preventing (if optimum levels of both are added) over-oxidation of the hindered phenol and inhibiting the formation of colored by-products. This preserves the phenolic for long term thermal stability. Blends of the phenolic antioxidant and a thioester are a good combination for long term thermal stability of the polymer.

Two main classes of antioxidants inhibit the initiation step in thermal auto-oxidation. The peroxide decomposers function by decomposing hydroperoxides through polar reactions. Metal deactivators are strong metal-ion complexing agents that inhibit catalyzed initiation through reduction and oxidation of hydroperoxides. The most important commercial propagation inhibitors are hindered phenols and secondary alkylaryl- and diarylamines.

Additional Antioxidants Include:

Sulfides: Dilauryl thiodipropionate and distearyl thiodipropionate are the most important commercial antioxidants in this class. They are used with phenols to give synergistic combinations.

Metal salts of dithioacids: These substances act as hydroperoxide decomposers and propagation inhibitors, and are used in conjunction with other antioxidants, particularly phenols.

Bound antioxidants: Recently, antioxidants have been developed that are copolymerized into the polymer chain. The main advantage of such a system is low antioxidant extractability in applications where the polymer is in contact with solvents capable of extracting conventional antioxidants.

Additional Additives Include:

Colorants: Preferably, for decorative reasons, colorants such as pigments and dyes that absorb light at specific wavelengths are added to the polymers of the present invention.

Plasticizers: The term “plasticizer” stems from the process of making the polymer more susceptible to plastic flow.

Plasticizers, preferably external plasticizers, are usually monomeric molecules that when mixed with polar or hydrogen bonded polymers, position themselves between these intermolecular bonds and increase the spacing between adjacent bonds. Of course they must also either be polar or be able to form hydrogen bonds. The result of this action is to lower the level of the strength of intermolecular forces, thus decreasing the mechanical strength and increasing the flexibility of the rigid structure. The plasticizer may preferably be introduced to the polymer by copolymerization. In this context copolymerization is sometimes referred to as internal plasticization.

Reinforcing Agents: This category of additives is very broad and yet very important in that such additives improve the mechanical properties of the base polymers, chiefly their strength and stiffness. Short and long glass fibers, graphite fiber are common additives in applications calling for improved mechanical properties, including the absence of creep (dimensional stability). Solid reinforcing agents also extend the upper temperature limit of the use of the base polymer.

Fillers: The main function of fillers is to reduce the cost of the end product. A very inexpensive filler, occupying a fraction of the volume of a plastic article, will have such an economic benefit. Nevertheless, fillers are also often specialty additives; they may be present to reduce the thermal expansion coefficient of the base polymer, to improve its dielectric properties, or to “soften” the polymers (e.g., calcium carbonate).

Lubricants: Lubricants are very low concentration additives that are mixed with polymers to facilitate their flow behavior during processing. There are two categories of lubricants, external and internal. External lubricants are incompatible at all temperatures with the polymer they are used with; therefore during processing they migrate to the melt-metal interface, promoting some effective slippage of the melt by reducing interfacial layer viscosity. Internal lubricants, on the other hand, are polymer compatible at processing temperatures, but incompatible at the use temperature. Therefore, during processing they reduce chain-to-chain intermolecular forces, thus melt viscosity. As the processed plastic products cool, they become incompatible (phase separation) and can eventually migrate to the surface; thus product properties are not permanently affected.

In an additional embodiment in accordance with the present invention, the polysuccinimide, or a copolymer thereof is processed in a processing equipment. The processing of polymers is discussed extensively in Principles of polymer Processing by R. T. Fenner, Chemical publishing (1979) and Principles of polymer Processing, by Z. Tadmor et al, John Wiley & Sons, New York, (1979) both of which are incorporated herein by reference. Following are some aspect concerning the processing of the materials of the present invention:

G. Processing

The materials of the present invention can be further processed by one of the principal methods used to process thermoplastic materials into finished or semifinished products, namely, screw extrusion, injection molding, blow molding and calendering. An important distinction exists between extrusion and calendering on the one hand, and molding techniques on the other, in that while the former are continuous processes, the latter are discontinuous. The term “materials of the present invention” is used to denote polysuccinimide and/or copolymers thereof and a blend thereof with an additive.

Screw Extrusion: In an embodiment in accordance with the present invention the materials of the present invention are extruded. The extrusion process is used to shape a molten polymeric material into a desired form by forcing it through a die. A variety of profiles can be formed in a continuous extrusion which include, but are not limited to, filaments, films and sheets. The required pressure is generated by at least one rotating screw in a heated barrel as shown in FIG. 1. While the form of the die determines the initial shape of the extrudate, its dimensions may be further modified, for example, by stretching, before final cooling and solidification takes place. A screw extruder may also be used, in accordance with the present invention, to further react the polyimide of the present invention by means of introducing a reactant in the extruder through an injection port as shown in FIG. 1. The segments of the extruder can be separately heated to different temperatures. Further, the position of the injection port can be moved to a different location along the screw of the extruder to facilitate different residence time and reaction time of the reactant within the extruder. It is also possible to add additional injection ports to facilitate the addition of different reactants that require different residence time in the extruder in order to facilitate to desired reaction.

Single-screw Extrusion: FIG. 1 shows the diagrammatic cross-section of a typical single-screw extruder, which is used to melt and to pump the polymer. Solid material in the form of either granules or powder is usually gravity fed through the hopper, although crammer-feeding devices are sometimes used to increase feed rates. The channel is relatively deep in the feed section, the main functions of which are to convey and compound the solids. Melting occurs as a result of the supply of heat from the barrel and mechanical work from the rotation of the screw.

The screw is held in position by an axial thrust bearing and driven by an electric motor via a reduction gearbox. Screw speeds are generally within the range of from 50 to 150 revolutions/minute, and it is usually possible to vary the speed of a particular machine over at least part of this range.

Barrel and die temperatures are maintained by externally mounted heaters, typically of the electrical-resistance type. Individual heaters or groups of heaters are controlled independently via thermocouples sensing the metal temperatures, and different zones of the barrel and die are often controlled at different temperatures. The region of the barrel around the feed pocket is usually water cooled to prevent fusion of the polymer feedstock before it enters the screw channels. Cooling may also be applied to part or all of the screw by passing water or other coolant through a passage at its center, access being via a rotary union on the driven end of the screw.

The size of an extruder is defined by the nominal internal diameter of the barrel. Sizes range from about 25 mm for a laboratory machine, through 60-150 mm for most commercial product extrusions, up to 300 mm or more for homogenization during polymer manufacture. Common thermoplastic extruders have screw length-to-diameter ratios of the order of 25 or more. An important characteristic of a screw is its compression ratio, one definition for which is the ratio between channel depths in the feed and metering sections. This ratio normally lies in the range of from 2 to 4, according to the type of material processed. Output rates obtainable from an extruder vary from about 10 kg/h for the smallest up to 5,000 kg/h or more for the largest homogenizers. Screw-drive power requirements are usually of the order of 0.1-0.2 kW h/kg.

Many modifications to the basic form of screw design can be used, often with the aim of improving mixing. Another variant is the two-stage screw, which is effectively two screws in series. The vent of the melt at the end of the first stage, where the screw channel suddenly deepens, makes it possible to extract through a vent any air or volatiles trapped in the polymer.

Multiscrew-Extrusion: In addition to single screw extruders, there are twin and multiscrew extruders performing substantially the same functions, twin-screw machines being the most common. Such extruders can have two screws intermeshing or not quite intermeshing, corotating or counterrotating. The more common intermeshing type have distinct advantages over single-screw machines in terms of an improved mixing action, and are not so much screw viscosity pumps as positive displacement pumps.

Extrusion Dies: The simplest extrusion dies are those used to make axisymmetric products such as lace and rod. The main design consideration with such dies is that changes in flow channel diameter from that of the extruder barrel bore to that of the die exit are gradual. Smooth melt flow is thus ensured, with no regions where material can be retained and degraded. In designing dies for more complicated profiles, due allowance must also be made for elastic recovery, which may cause changes in shape after the extrudates leave the dies. Other types of extrusion die are used in the production of flat film, sheet, pipe and tubular film, and in covering wire and cable.

Flat-film and Sheet Extrusion: The distinction between flat film and sheet is one of thickness, both being extruded in similar types of dies. As the widths of such flat sections are much greater than the extruder-barrel diameters, the dies must spread the melt flow laterally and produce extrudates of as uniform a thickness as possible.

Pipe, Tube and Profile Extrusion: Pipe, tube and profile extrusion process is another extrusion operation. Pipes and tubes are usually distinguished by size. Below 1.25 cm (0.5 in) diameter is called a tube; above 1.25 cm (0.5 in) diameter is called a pipe.

Wire and Cable Covering: Wire and cable covering operations are carried out over a very wide range of line speeds, from about 1 m/min for large high-voltage electrical cables to 1,000 m/min or more for small-diameter wires. Nevertheless, the types of die used are similar, being of the crosshead type to accommodate the conductor entering at an angle—often a right angle—to the axis of the extruder. The success of such an arrangement depends on the design of the flow deflector, which serves to distribute the melt into a layer of uniform thickness on the conductor.

Injection Molding: The term “injection molding” as used herein denotes the process for producing substantially identical articles from a hollow mold. In the injection molding process, molten polymer is forced under high pressure into a closed mold of the required shape, where it is cooled before the mold is opened and the finished article extracted.

Blow Molding: Blow molding is used for the formation of hollow articles, such as bottles and other containers, manufactured by the blow molding process. The blow molding process involves first the formation of a molten parison, which is a preshaped sleeve, usually made by extrusion. Air is blown into the parison surrounded between two mold halves expending the parison and causing it to take the shape of the mold. The polymer solidifies and the hollow article is ejected.

Calendering: The term “calendering” as used herein denotes a process for producing continuous films or sheets by pressing molten polymer between rotating rolls.

Another process that is very important for the production of fibers and filaments is that of spinning. Melt supplied by either an extruder or gear pump is forced vertically downwards through a series of very small holes in a flat plate or spinneret, and the resulting threads are air cooled and rapidly stretched by winding at high speed on to a bobbin.

Further, the polymers and copolymer of the present invention can be worked by engineering techniques including welding, cutting and machining, although to do so to any significant extent is to lose the advantage offered by polymeric materials over metals in terms of ease of fabrication.

Having generally described this invention, a further understanding can be obtained by reference to certain specific examples which are provided herein for purposes of illustration only and are not intended to be limiting unless otherwise specified.

### EXAMPLES

The following reactions are all run in the same manner. Essentially 1 mole of the end-cap initiator, acid functionality, is reacted with X moles of L-aspartic acid in a rotor evaporator at 120 to 220° C. for 2 to 4 hours. In general the temperature is brought up to 180° C. before the vacuum is turned on. Table 1 is a compilation of the trials run to date, listing the acid end capping initiator used and the ratio of end-cap to L-aspartic acid.

TABLE 1
Molar Ratio of End capping Initiator to L-aspartic Acid

| | Molar Ratio of |
|---|---|
| End Capping Initiator | End-Cap:L-Aspartic Acid |
| Succinic Anhydride | 1:1, 1:2, 1:5 |
| Phthalic Anhydride | 1:1, 1:2, 1:5, 1:10 |
| Maleic Anhydride | 1:1, 1:2 |
| Benzoic Acid | 1:1, 1:2 |
| Azelaic Acid | 1:1, 1:4 |
| Adipic Acid | 1:2 |

1, Preparation of Succinic Anhydride-Aspartic Acid 1:2 Molar Ratio

10 grams (0.1 mole) of succinic anhydride was mixed with 26.6 grams (0.2 moles) of L-aspartic acid in a heavy walled pressure test tube with Teflon screw cap and O-ring. The tube was placed into an oven at 185° C. The reaction mixture was a thick, bright yellow syrup. The reaction was allowed to proceed for 4 hours. The hot product was poured onto aluminum foil and allowed to cool. When cooled the product was a clear glassy fairly brittle film.

Titration of this product yielded a carboxylic acid titer of 6.36 mEq/g and upon hydrolysis the titer of the sodium salt was 13.37 mEq/g. Therefore, the ring closed fraction is the difference:—7.01 mEq/g. Theoretical values for these are 6.80, 13.61, and 6.81 mEq/g, respectively

An FTIR scan of this product shows a peak at 1717 wavenumbers representing the succinimide peak.

2. Preparation of Phthalic Anhydride-Aspartic Acid 1:2 Molar Ratio.

14.81 grams (0.1 mole) of phthalic anhydride was mixed with 26.62 grams (0.2 moles) of L-aspartic acid in a heavy walled pressure test tube with Teflon screw cap and O-ring. The tube was placed into an oven at 190-197° C. At 2 hours the material in the tube was molten. The reaction was allowed to proceed for a total of 2.5 hours. The hot product was poured onto aluminum foil and allowed to cool. When cooled the product was a tan cloudy brittle material easily ground into a powder.

This had been run in duplicate. Titration of these products yielded a carboxylic acid titer of 5.83/5.63 mEq/g and upon hydrolysis the titer of the sodium salt was 11.52/11.14 mEq/g. Therefore the ring closed fraction is the difference: 5.69/5.51 mEq/g. Theoretical values for these are 5.85, 11.70, and 5.85 mEq/g, respectively

An FTIR scan of this product shows a peak at 1714 wavenumbers.

3. Preparation of Adipic Acid:L-Aspartic Acid 1:2 Molar Ratio

In a similar manner 14.4 grams (0.1 mole) of adipic acid was mixed with 26.62 grams (0.2 moles) of L-aspartic acid. The reaction was run in the oven at 180° C. for 4 hours. Titration of these products yielded a carboxylic acid titer of 7.58 mEq/g and upon hydrolysis the titer of the sodium salt was 11.53 mEq/g. Therefore the ring closed fraction is the difference: 3.95 mEq/g. Theoretical values for these are 8.88, 11.76, and 2.88 mEq/g, respectively

4. Preparation of Succinic Anhydride:Copoly(succinimide-aspartate) 1:26 Molar Ratio

To a 1 L flask 0.15 g (1.5 mM) is added to 10 g of a 70% solution of Sodium Aspartate/Ammonium Aspartate (1:1 molar ratio) which contains 39 mM of Aspartate. The water was evaporated on a rotary evaporator and then the temperature of the oil bath was raised to 185° C. The reaction was run for 3 hours. The product was a tan/yellow solid which is ground into a powder. Titration yielded a COOH content of 5.11 mEq/g as is and after hydrolysis of the succinimide residues the COOH content was 8.86 mEq/g, therefore the succinimide content of the product was 3.75 nEq/g. The IR shows a succinimide peak at 1715 wave numbers and an amide peak at 1617 wave numbers. Molecular weight of the hydrolysate was 1734 Da. by GPC.

5. The preparation of Succinic Anhydride:Co(polysuccinimide/aspartate) 1:10 Molar Ratio

To a 1 L flask 3.7 g (37 mM) is added to 100 g of a 70% solution of NaAspartate/Ammonium Aspartate (1:1 molar ratio) which contains 370 mM of Aspartate. The water was evaporated on a rotary evaporator and then the temperature of the oil bath was raised to 185° C. The reaction was run for five hours. Titration yielded a COOH content of 4.85 mEq/g as is and after hydrolysis of the succinimide residues the COOH content was 8.86 mEq/g. Therefore the succinimide content of the product was 4.01 mEq/g. The IR shows a succinimide peak at 1715 wave numbers and an amide peak at 1611 wave numbers. There is also a shoulder on the succinimide peak at 1777 wave numbers which is attributed to a succinic anhydride end group. The molecular weight of the hydrolysate was 1941 Da. by GPC.

6. Synthesis of End-Capped Polysuccinimide in an Extruder

A twin-screw extruder which has a 30 mm barrel was used to synthesize an end-capped polysuccinimide. The extruder was set up with various zones allowing for the temperatures to be set appropriately. The extruder was run at a feed rate of 50 g/min. The feed for the extruder was mixed up in 3 kg batches as solid pre-mixes which were put into the hopper and fed as a powder into the first zone of the extruder. Feed compositions for two ratios studied are listed in the following table:

| Molar ratio | Weight of succinic | Weight of aspartic |
|---|---|---|
| aspartic:succinic | anhydride | acid |
| 4:1 | 475 g | 2525 g |
| 6:1 | 335 g | 2665 g |

7. Extruder Synthesis of Aspartic:Succinic 4:1

At this ratio the mixture formed a very thick melt at a barrel temperature of about 232° C. (450° F.). This product emerged from the end of the extruder as a thick paste. FTIR analysis of the product showed a strong imide peak, indicating that the desired reaction had occurred.

8. Extruder Synthesis of Aspartic:Succinic 6:1

At a barrel temperature of about 232° C. (450° F.), this product emerged from the end of the extruder as a thick paste. FTIR analysis of the product showed a strong imide peak, indicating that the desired reaction had occurred.

Obviously, numerous modifications and variations of the present invention are possible in light of the above teachings. It is therefore to be understood that within the scope of the appended claims, the invention may be practiced otherwise than as specifically described herein.

1. A method for preparing a polymeric material comprising succinimide moieties, which comprises polymerizing, in the absence of an amine, a dicarboxylic amino acid in the presence of an end capping initiator to form the polymeric material.

2. The method of claim 1, wherein said dicarboxylic amino acid is L-aspartic acid and said polymeric material is polysuccinimide.

3. The method of claim 1, wherein said end capping initiator is selected from the group consisting of a carboxylic anhydride of formula (A): 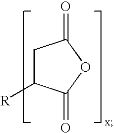
an acid of formula (B): R (CO₂H)ₓ; and an ester of formula (C):
R(CO₂R₁)ₓ, and wherein said end capping initiator is in the absence of an amine.

4. The method of claim 3, wherein integer x of said formula (A), (B) or (C) is from 1 to 2,000.

5. The method of claim 3, wherein x of said formula (A), (B) or (C) is from 1 to 1,000.

6. The method of claim 3, wherein x of said formula (A), (B) or (C) is from 1 to 100.

7. The method of claim 3, wherein x of said formula (A), (B) or (C) is from 1 to 10.

8. The method of claim 3, wherein x of said formula (A), (B) or (C) is from 1 to 5.

9. The method of claim 3, wherein x of said formula (A), (B) or (C) is from 1 to 3.

10. The method of claim 3, wherein R and R₁ of said formula (A), (B) or (C) are the same or different radicals selected from the group consisting of hydrogen, an alkyl, a substituted alkyl, an alkenyl, an aryl, an aryl-alkyl, and a substitute aryl radical.

11. The method of claim 10, wherein said alkyl is selected from the group consisting of methyl, ethyl, n-propyl, isopropyl, n-butyl, isobutyl, sec-butyl, n-amyl, isoamyl, n-hexyl, n-octyl, capril, n-decyl, lauryl, myristyl, cetyl and stearyl.

12. The method of claim 10, wherein said substituted alkyl is selected from the group consisting of hydroxyethyl and polyoxyalkyl.

13. The method of claim 10, wherein said alkenyl is allyl.

14. The method of claim 10, wherein said aryl is selected from the group consisting of phenyl and naphthyl.

15. The method of claim 10, wherein said aryl-alkyl is benzyl.

16. The method of claim 10, wherein said substituted aryl is selected from the group consisting of alkylphenyl, chlorophenyl and nitrophenyl.

17. The method of claim 3, wherein R of said formula (A), (B) or (C) is independently a hydrogen atom.

18. The method of claim 3, wherein x of said formula (A), (B) or (C) is 1 or 2, and said polysuccinimide is a linear polymer.

19. The method of claim 3, wherein x of said formula (A), (B) or (C) is 3 or higher, and said polysuccinimide is a star polymer.

20. The method of claim 3, wherein group R of said formula (A), (B) or (C) contains a functional group.

21. The method of claim 1, wherein said end capping initiator contains at least one carboxyl group and wherein the polysuccinimide formed is in the absence of an amine functionality.

22. The method of claim 1, wherein said end capping initiator is a polymeric material containing at least one end capping functional group.

23. The method of claim 22, wherein said polymeric material is an acrylic or styrenic copolymer and wherein said end capping functional group is a carboxyl group or an anhydride group.

24. The method of claim 3, wherein said acid is selected from the group consisting of HCOOH, CH₃(CH₂)ₙCOOH, where n is from 0 to 16, and HOOC(CH₂)ₙCOOH, where n is from 4 to 16.

25. The method of claim 1, wherein said end capping initiator is selected from the group consisting of a hydroxyl terminated material, poly(vinyl alcohol), a polyester, a polyamide, a polysaccharide, a protein, a dye, a polymeric material containing at least one functionality and a UV absorber.

26. The method of claim 25, wherein said functionality of said polymeric material is selected from the group consisting of an anhydride, a carboxylic acid and an ester.

27. The method of claim 25, wherein said polymeric material is styrene-maleic anhydride.

28. The method of claim 25, wherein said polymeric material exhibits a weight average molecular of 1,000 or higher.

29. The method of claim 25, wherein said polymeric material exhibits a weight average molecular of from 2,000 to 50,000.

30. The method of claim 1, wherein said polymerization is carried out in a medium selected from the group consisting of a solid phase polymerization, melt polymerization, polymerization in dispersion in oil, polymerization in solution in oil, polymerization in phosphoric acid and polymerization in a supercritical fluid.

31. The method of claim 1, wherein said polymeric material is a prepolymer.

32. The method of claim 31, wherein said prepolymer exhibits a weight average molecular weight of from 100 to 1,000 Daltons.

33. The method of claim 31, wherein said prepolymer is further polymerized by a method selected from the group consisting of a thermal process, a supercritical fluid process, polymerization in the molten phase and polymerization in the solid phase.

34. The method of claim 1, wherein said end capping initiator and said dicarboxy amino acid are present in a ratio of from 1:1 to 1:1000.

35. The method of claim 1, wherein said end capping initiator and said dicarboxy amino acid are present in a ratio of from 1:1 to 1:100.

36. The method of claim 1, wherein said end capping initiator and said dicarboxy amino acid are present in a ratio of from 1:1 to 1:10.

37. The method of claim 1, wherein said end capping initiator and said dicarboxy amino acid are present in a ratio of from 1:1 to 1:5.

38. The method of claim 1, wherein said dicarboxylic amino acid is selected from the group consisting of glutamic acid, α,ε-diaminopimelic acid and γ-methylene glutamic acid.

39. The method of claim 1, wherein said polymeric material is an oligomer.

40. The method of claim 2, wherein said polysuccinimide exhibits a weight average molecular weight of from 1,000 to 500,000.

41. The method of claim 2, wherein said polysuccinimide exhibits a weight average molecular weight of from 1,000 to 50,000.

42. The method of claim 2, wherein said polysuccinimide exhibits a weight average molecular weight of from 2,000 to 10,000.

43. The method of claim 39, wherein said oligomer undergoes chain extension in an extruder.

44. The method of claim 2, wherein an anhydride end of said polysuccinimide further reacts with a primary or secondary amine.

45. The method of claim 1, wherein said polymerization is carried out in the presence of a stabilizer.

46. The method of claim 45, wherein said stabilizer is selected from the group consisting of a thermal stabilizer, an antioxidant and a mixture thereof.

47. A method for preparing polysuccinimide from L-aspartic acid which comprises polymerizing L-aspartic acid in the presence of an end capping initiator and a catalyst to form the polysuccinimide.

48. The method of claim 47, wherein said catalyst is selected from the group consisting of phosphoric acid, a Lewis acid and an organometallic catalyst.

49. The method of claim 48, wherein said organometallic catalyst is tin octanoate.

50. The method of claim 2, wherein said polysuccinimide is isolated and blended with a polymer additive.

51. The method of claim 50, wherein said polymer additive is selected from the group consisting of a stabilizer, an antioxidant, a hindered phenol, an amine, a phosphite, a thioester, a sulfite, a metal salt of a dithioacid, a colorant, a plasticizer, a reinforcing agent and a lubricant.

52. An article prepared by processing the polysuccinimide of claim 2.

53. The article of claim 52, wherein said processing is selected from the group consisting of extrusion, injection molding, blow molding and calendering.

54. The method of claim 30, wherein said supercritical fluid is selected from the group consisting of CO₂, NH₃, H₂O, N₂O, xenon, krypton, methane, ethane, ethylene, propane, pentane, methanol, ethanol, isopropanol, isobutanol, CClF₃, CFH₃, cyclohexanol, CS₂, and a mixture thereof.

55. The method of claim 30, wherein said supercritical fluid is maintained at a pressure of from about 500 psi to about 2500 psi.

56. The method of claim 30, wherein said supercritical fluid is maintained at a pressure of from about 700 psi to about 2000 psi.

57. The method of claim 30, wherein said supercritical fluid is maintained at a temperature of from about 50° C. to about 300° C.

58. The method of claim 30, wherein said supercritical fluid is maintained at a temperature of from about 100° C. to about 250° C.

59. The method of claim 30, wherein the weight average molecular weight of the polyimide is in the order of from about 2,000 to about 10,000 Dalton.

60. The method of claim 30, wherein the weight average molecular weight of the polysuccinimide is in the order of from about 3,000 to about 5,000 Daltons.

61. The method of claim 2, wherein said polysuccinimide is reacted with an additional monomer to form a block copolymer.

62. The method of claim 2, wherein said polysuccinimide is hydrolyzed to form a polyaspartate.

63. The polysuccinimide formed by the method of claim 2.

64. The polyaspartate formed by the method of claim 62.

65. The linear polymer formed by the method of claim 19.

66. The star polymer formed by the method of claim 18.

67. The block copolymer formed by the method of claim 61.

68. A method for preparing a polymeric material containing imide moieties, comprising polymerizing at least one dicarboxy amino acid in the presence of an end capping initiator to form polymeric material; wherein said polymeric material is in the absence of aspartate moieties.

69. The method of claim 68, wherein said polymeric material is a (co)polyimide.

70. The method of claim 68, wherein said dicarboxylic amino acid is selected from the group consisting of glutamic acid, α,β-diaminopimelic acid and γ-methylene glutamic acid.
